(19) United States
(12) Patent Application Publication
(10) Pub. No.: US 2022/0222129 A1
(43) Pub. Date: Jul. 14, 2022

(54) SYSTEM FOR PARALLEL PROCESSING MIDDLEWARE NODE APPLICATION ALGORITHMS USING THREADS

(71) Applicant: GM GLOBAL TECHNOLOGY OPERATIONS LLC, Detroit, MI (US)

(72) Inventors: Shige WANG, Northville, MI (US); Wei Tong, Troy, MI (US); Shuqing Zeng, Sterling Heights, MI (US)

(21) Appl. No.: 17/147,043

(22) Filed: Jan. 12, 2021

(51) Int. Cl. G06F 9/52; G06F 9/50; G06T 1/20; G06T 1/60

(52) U.S. Cl. CPC G06F 9/52; G06T 1/60; G06T 1/20; G06F 9/5016

(57) ABSTRACT

A system includes a queue, a memory and a controller. The queue is configured to transfer a message between a first thread and a second thread, where the first thread and the second thread are implemented as part of a single process, and where an amount of data corresponding to the message is less than a set amount of data. The memory is configured for sharing data between the first thread and the second thread, wherein an amount of the data shared between the first thread and the second thread is greater than the set amount of data. The controller is configured to execute the single process including concurrently executing (i) a first middleware node process as the first thread, and (ii) a second middleware node process as the second thread.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to middleware node processing.

A vehicle may include numerous sensors, such as cameras, infrared sensors, radar sensors, lidar sensors, etc. A middleware framework may be used to collect, process, and analyze data collected from the sensors. Various actions may then be performed based on the results of the analysis. The middleware framework may include multiple controllers implementing respective processes, where each process may be a sub-program within an application. Each process may be implemented on a dedicated controller, where each controller includes one or more cores (or central processing units). A controller may be referred to as a multi-core processor.

As an example, a camera may capture images. A first controller may perform a detection process including receiving and coordinating processing of the images to detect and identify objects in the images. A second controller may perform a segmentation process and receive results of the processing performed by the first controller and coordinate further processing to determine locations of the identified objects relative to the vehicle. Each of the controllers may instruct a same graphics processing unit (GPU) to perform certain computations for each of the respective processes. The processing performed by the GPU is time multiplexed and performed in a sequential manner. The time multiplexing of the computations for the respective processes has associated delays and tends to underutilize GPU resources.

### SUMMARY

A system is provided and includes a queue, a memory, and a controller. The queue is configured to transfer a message between a first thread and a second thread, where the first thread and the second thread are implemented as part of a single process, and where an amount of data corresponding to the message is less than a set amount of data. The memory is configured for sharing data between the first thread and the second thread, where an amount of the data shared between the first thread and the second thread is greater than the set amount of data. The controller is configured to execute the single process including concurrently executing (i) a first middleware node process as the first thread, and (ii) a second middleware node process as the second thread.

In other features, the first thread and the second thread share a same region of a main memory address space of the memory for thread code, thread data, graphics processing module code, and graphics processing module data.

In other features, the system further includes a graphics processing module comprising an execution module configured to execute code for the first thread concurrently with code for the second thread.

In other features, the system further includes a graphics processing module comprising an copy module configured to copy graphics processing module data for the first thread concurrently with graphics processing module data for the second thread.

In other features, the system further includes: a graphics processing module memory; and a graphics processing module configured to concurrently transfer data for the first thread and the second thread between a main memory address space of the memory and the graphics processing module memory.

In other features, the system further includes a graphics processing module. The first thread generates first computations for a first algorithm of the first middleware node. The second thread generates second computations for a second algorithm of the second middleware node. The graphics processing module concurrently executes the first computations for a second frame while executing the second computations for a first frame, where the second frame is captured and received subsequent to the first frame.

In other features, the first thread and the second thread are implemented as part of a single middleware node.

In other features, the controller is configured to: allocate and define a main memory address space of the memory to be shared by the first thread and the second thread; and define the queue to be used by the first thread and the second thread.

In other features, the main memory address space is dedicated for reading and writing operations. The queue is dedicated for sending and receiving operations.

In other features, the controller is configured to: determine whether use of the queue is appropriate, and if appropriate, connecting to the queue if allocated and allocating the queue if not allocated; and determine whether use of a shared region of the memory is appropriate, and if appropriate, accessing the shared region if allocated and allocating the shared region if not allocated.

In other features, a method is provided and includes: allocating a queue for transfer of a message between a first thread and a second thread, where the first thread and the second thread are implemented as part of a single process, and where an amount of data corresponding to the message is less than a set amount of data; allocating a memory for sharing data between the first thread and the second thread, where an amount of the data shared between the first thread and the second thread is greater than the set amount of data; and executing the single process including concurrently executing (i) a first middleware node process as the first thread, and (ii) a second middleware node process as the second thread.

In other features, the first thread and the second thread share a same region of a main memory address space of the memory for thread code, thread data, graphics processing module code, and graphics processing module data.

In other features, the method further includes executing code via a graphics processing module and for the first thread concurrently with code for the second thread.

In other features, the method further includes copying graphics processing module data via a graphics processing module and for the first thread concurrently with graphics processing module data for the second thread.

In other features, the method further includes concurrently transferring data for the first thread and the second thread between a main memory address space of the memory and a graphics processing module memory.

In other features, the method further includes: generating first computations via the first thread for a first algorithm of the first middleware node; and generating second computations via the second thread for a second algorithm of the second middleware node; and concurrently executing via a graphics processing module the first computations for a second frame while executing the second computations for a first frame, where the second frame is captured and received subsequent to the first frame.

In other features, the first thread and the second thread are implemented as part of a single middleware node.

In other features, the method further includes: allocating and define a main memory address space of the memory to be shared by the first thread and the second thread; and defining the queue to be used by the first thread and the second thread.

In other features, the main memory address space is dedicated for reading and writing operations. The queue is dedicated for sending and receiving operations.

In other features, the method further includes: determining whether use of the queue is appropriate, and if appropriate, connecting to the queue if allocated and allocating the queue if not allocated; and determining whether use of a shared region of the memory is appropriate, and if appropriate, accessing the shared region if allocated and allocating the shared region if not allocated.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1A is a functional block diagram of an example middleware framework implementing middleware nodes as processes;

FIG. 1B is a timing diagram illustrating sequence of processing events performed by central processing units (CPUs) and GPU of the middleware framework of FIG. 1;

FIG. 2 is a functional block diagram illustrating memory usage and GPU processing for the processes performed by the middleware nodes of FIG. 1A;

FIG. 3 is a functional block diagram of a vehicle including a middleware framework implementing middleware nodes and corresponding algorithms as threads of a single process in accordance with the present disclosure;

FIG. 4 is a functional block diagram of an example middleware node including threads and accessing a queue and a shared main memory in accordance with the present disclosure;

FIG. 5 a functional block diagram illustrating shared memory usage of threads and parallel GPU processing for the threads as performed by the middleware node of FIG. 4 in accordance with the present disclosure;

FIG. 6 illustrates mapping communication differences between process-based message transfers and thread-based message transfers of small amounts of data in accordance with the present disclosure;

FIG. 7 illustrates mapping communication differences between process-based message transfers and thread-based message transfers of large amounts of data in accordance with the present disclosure;

FIG. 8 illustrates differences between process-based mapping and thread-based mapping of scheduled parameters in accordance with the present disclosure;

FIG. 9 illustrates a mapping method for defining a queue and a shared main memory space in accordance with the present disclosure; and

FIG. 10 illustrates a thread initialization method in accordance with the present disclosure.

In the drawings, reference numbers may be reused to identify similar and/or identical elements.

### DETAILED DESCRIPTION

Middleware nodes running as processes forces a GPU to work from different middleware nodes using time multiplexing to schedule computations to be performed for each of the nodes. A GPU may include hundreds of cores. The time multiplexing of the computations is not only time consuming, but also underutilizes the GPU resources because only a small percentage of the GPU cores are used at any moment in time to performed the corresponding computations. The implementing of the middleware nodes as processes using time multiplexing results in low throughput of algorithms, underutilization of hardware, and long processing delays.

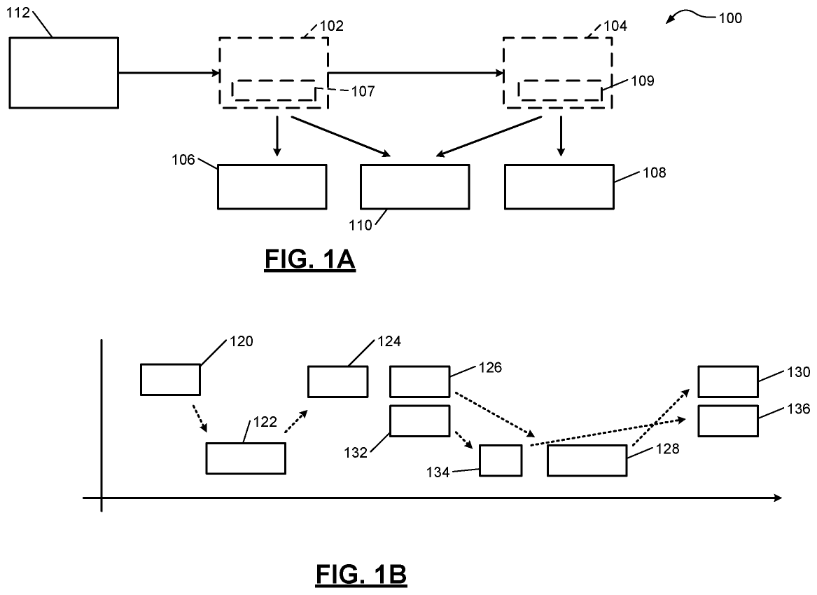

FIG. 1A shows an example middleware framework 100 implementing middleware nodes 102, 104 as processes executed via a first CPU 106, a second CPU 108 and a GPU 110. Although shown as CPUs 106, 108, the CPUs 106, 108 may be replaced with respective controllers. The CPUs 106, 108 may be implemented in a vehicle or one of the CPUs may be implemented in the vehicle and the other one of the CPUs may be implemented at a remote location away from the vehicle. This also holds true for the controllers. As used herein, the terms CPU and GPU may be referred to as central processing modules and graphics processing modules.

In the example shown, a sensor 112 (e.g., a camera) generates an output signal including data (e.g., a captured image), which is provided to the first node 102. The first node 102 may be implemented via the first CPU 106 and the GPU 110. The second node 104 may be implemented by the second CPU 108 and the GPU 110. The first CPU 106 coordinates operations to be performed for the first process (or first algorithm 107). The second CPU 108 coordinates operations to be performed for the second process (or second algorithm 109). The CPUs 106, 108 instruct the GPU 110 to perform certain computations for the respective processes. The CPUs 106, 108 may implement respective neural networks (e.g., convolutional neural networks).

FIG. 1B shows a timing diagram illustrating sequence of processing events performed by the CPUs 106, 108 and GPU 110 of the middleware framework. In the example shown, the first CPU 106 receives

a first image and while implementing the first node N1 executes first code c1 and instructs the GPU 110 to perform computations (or operations) g11, g12. The first CPU 106 then receives results of the computations performed by the GPU 110 and executes second code c2. The computations may be referred to as kernels, which the GPU 110 performs and generates corresponding resultant output data. This process is illustrated by boxes 120, 122, 124. As an example, this may provide detected object information. The first CPU 106 provides the first image and the detected object information to the second CPU 108. The first CPU 106 then repeats this process for a next (or second) image (illustrated by boxes 126, 128, 130).

The second CPU 108 receives the first image and the results of executing the second code c2 and executes the first code c1 for the second node N2, which is different than the code c1 for the first node N1. The second CPU 108 then instructs the GPU to perform computations (or operation) g21. The second CPU 108 then receives results of the computations performed by the GPU 110 and executes second code c2. This process is illustrated by boxes 132, 134 and 136. The process of the second CPU 108 may be performed for segmentation reasons and/or, for example, to align image, object information, and/or other sensor data to determine a location of an object. The GPU 110 may provide feedback to the second CPU 108, and then the second CPU 108 determines coordinates of the object. The GPU may provide an array of data to the first CPU 106 and second CPU 108. The CPUs 106, 108 may identify the object and determine where the object is located, as well as confidence levels associated with the identification and the determined location. The second CPU 108 may display objects as, for example, boxes on an image. Examples, of some of the operations performed by the CPUs 106, 108 include pulling, full connect and convolutional operations.

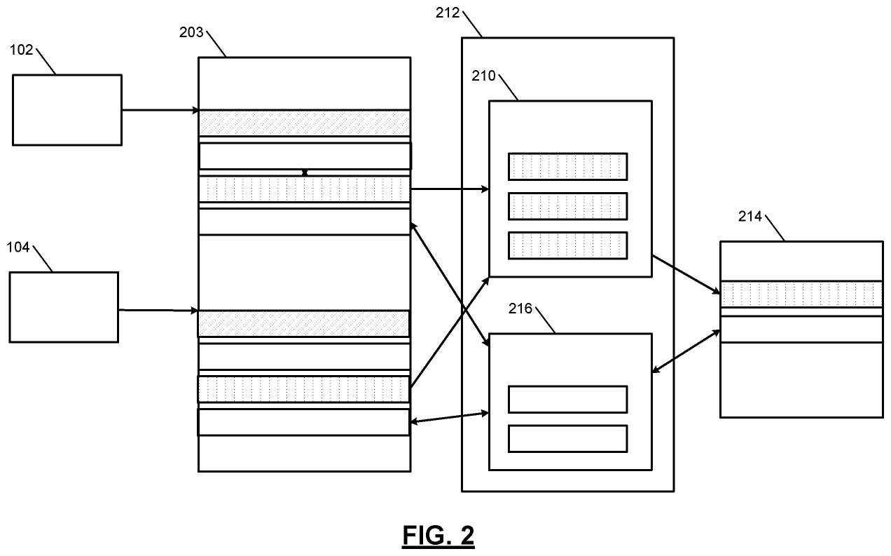

FIG. 2 shows a diagram illustrating memory usage and GPU processing for the processes performed by the middleware nodes 102 (N1), 104 (N2) of FIG. 1. The first node N1 may be implementing a first process of an operating system according to a first algorithm. The second node N2 may be implementing a second process of an operating system according to a second algorithm. Each process uses a dedicated region of main memory address space. Two regions 200, 202 are shown as part of a main memory address space 203 and are separate from each other. The processes do not share the same memory region and have dedicated separately located memory spaces for both code and data.

When a process is created, a table is used to indicate available memory space in the main memory for the process. The table indicates what memory can be used for the process as needed while the process is being executed. Each process is allocated a different memory region from which available memory can be accessed and used.

As shown, the first region 200 includes first code for the first node N1:c1, second code for the first node N1:c2, first node N1 data, computations g11, g12 for the GPU 110, and first GPU data g1, which may include results of the computations g11, g12. The second region 202 includes first code for the second node N2:c1, second code for the second node N2:c2, second node N2 data, computation g21 for the GPU 110, and second GPU data g2, which may include results of the computations g21. The GPU code (or computations) g12, g11, g21 from different nodes is submitted to be executed by an execution engine (or execution module) 210 of a GPU driver 212 of the GPU 110 and time multiplexed and thus executed one at a time. Dedicated memory space may be provided for the GPU code and GPU data that is not shared. Data for the GPU computations is also copied to the GPU memory 214 in a sequential (one at a time) manner. A copy engine (or copy module) 216 of the GPU driver 212 sequentially copies the GPU data to and from the regions 200, 202 and the GPU memory 214. The stated operations implicitly force serial execution of the nodes N1, N2 (referred to as hidden serialization). The GPU driver 212 does not permit two separate processes to be performed concurrently, but rather forces serialization of N1 and N2 related code and data. The CPUs 106, 108 and the GPU 110 may perform (or repeat) the same operations for each image received.

The examples set forth herein include a thread-based middleware framework that implements middleware nodes as threads as part of a single process for a resultant single middleware node. This provides a higher degree of parallelism for processing when implementing middleware nodes (e.g., robotic operating system (ROS) nodes or other middleware nodes). A ROS node is a type of middleware node that may be used for an autonomous driving system. Each of the middleware nodes may be implemented in a one or more processors (or cores) of a single controller.

As used herein the term “program” may refer to code stored in memory and executed by a controller to fulfill one or more tasks. A program may be part of an operating system or separate from the operating system. The programs may be referred to as applications. The program needs memory and various operating system resources in order to run. A “process” refers to a program that has been loaded into memory along with all the resources the program needs to operate. When a process starts, the process is assigned memory and resources.

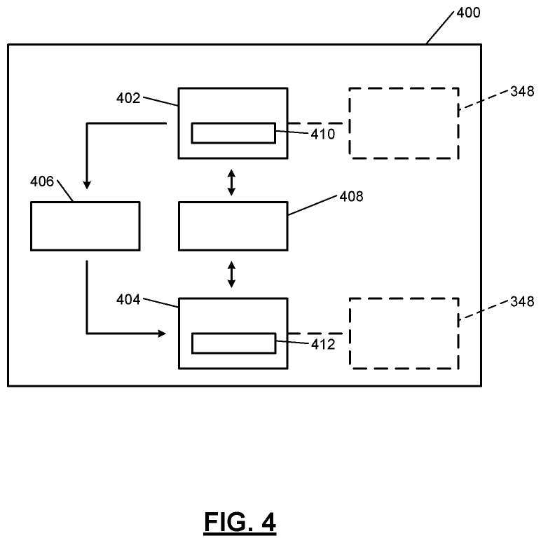

As used herein a “thread” is a unit of execution within a process. A process can have anywhere from just one thread to many threads. The threads of a process share memory and resources. The threads may be executed during overlapping time periods and/or simultaneously. The threads of a middleware node, such as that shown in FIG. 4, cannot be implemented by separate controllers (or multi-core processors). This is unlike processes, which may implemented by separate controllers (or multi-core processors). When a first thread is created, a segment of memory allocated for a corresponding process is assigned to the first thread. This allows another created thread to share a same allocated memory region with the first thread. Threads of a process have similar addresses referring to segments of a same memory region. The size of the shared memory region may be dynamic and change as additional memory is needed and/or additional threads for the process are created.

The disclosed examples include a multi-thread runtime system and a method to configure a process-based node system to a system allowing multiple threads implementing middleware node algorithms to be executed concurrently. The system has a middleware architecture with a multi-thread model of a middleware node. Architectural mechanisms are provided for thread communications and parallel execution of GPU requests using queues and shared memory based on the data exchanged. A method is provided for converting a process-based middleware nodes to a multi-thread middleware node is provided.

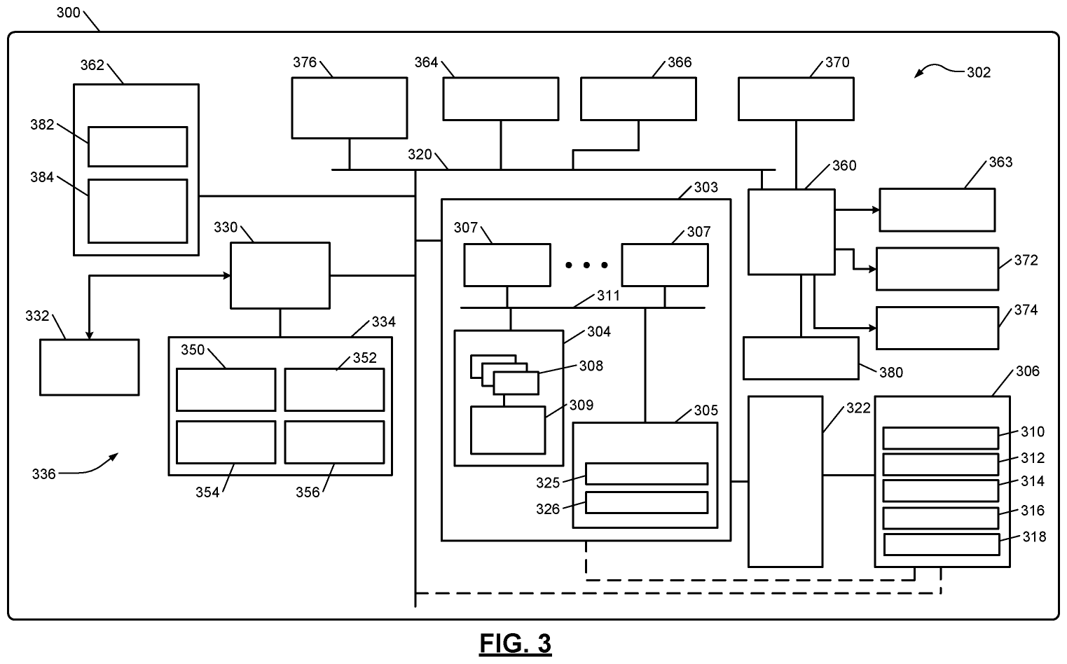

FIG. 3 shows a vehicle 300 including a middleware framework (or middleware system) 302 configured to implement middleware nodes and corresponding algorithms as respective threads. The vehicle 300 may be a partially or fully autonomous vehicle or other vehicle. An example middleware node is shown in FIG. 4. The middleware framework 302 may include one or more controllers (One controller 303 is shown) and sensors 306. The controllers implement a middleware service, which may include open source software and include execution of middleware nodes. The middleware service and corresponding system provides transparency between applications and hardware. The middleware system is not an operating system and makes implementation of applications easier. The middleware system allows for transparent communication between applications. This means that the applications can be located anywhere, such as in a same computer, a vehicle memory, an edge cloud computing device, a cloud-based network device, or elsewhere. The applications may run on a same core or different cores. If one application calls the middleware service to reach a second application, a signal is generated and routed to the second application by the middleware service.

Each of the controllers may implement a respective neural network and include one or more processors (or cores). In one embodiment, the controllers implement respective convolutional neural networks. Each middleware node may be implemented on one or more cores (or CPUs) of a selected one of the controllers. Each middleware node cannot be implemented on more than one of the controllers. In addition to implementing middleware nodes as threads and as part of a single process, the one or more of the controllers may also implement middleware nodes as separate processes as described above with respect to FIGS. 1A-2.

Each of the controllers may include CPUs (or central processing modules) 307, a GPU 304 and a main memory 305. The GPU 304 may include cores 308 and a device memory 309. The CPUs 307, the GPU 304 and the main memory 305 may communicate with each other via an interface (or bus) 311. The sensors 306 may be located throughout the vehicle 300 and include cameras 310, infrared (IR) sensors 312, radar sensors 314, lidar sensors 316, and/or other sensors 318. The controllers and sensors 306 may be in direct communication with each other, may communicate with each via a controller area network (CAN) bus 320, and/or via an Ethernet switch 322. In the example shown, the sensors 306 are connected to the controllers via the Ethernet switch 322, but may also or alternatively be connected directly to the controllers 202 and/or the CAN bus 320. The main memory 305 may store, for example, code 325 and data 326. The data 326 may include parameters referred to herein and other data. The code 325 may include algorithms referred to herein.

The vehicle 300 may further include a chassis control module 330, torque sources such as one or more electric motors 332 and one or more engines (one engine 334 is shown). The chassis control module 330 may control distribution of output torque to axles of the vehicle 300 via the torque sources. The chassis control module 330 may control operation of a propulsion system 336 that includes the electric motor(s) 332 and the engine(s) 334. The engine 334 may include a starter motor 350, a fuel system 352, an ignition system 354 and a throttle system 356.

The vehicle 300 may further include a body control module (BCM) 360, a telematics module 362, a brake system 363, a navigation system 364, an infotainment system 366, an air-conditioning system 370, other actuators 372, other devices 374, and other vehicle systems and modules 376. The other actuators 372 ma include steering actuators and/or other actuators. The controllers, systems and modules 303, 330, 360, 362, 364, 366, 370, 376 may communicate with each other via the CAN bus 320. A power source 380 may be included and power the BCM 360 and other systems, modules, controllers, memories, devices and/or components. The power source 380 may include one or more batteries and/or other power sources. The controllers 303 may and/or the BCM 360 may perform countermeasures and/or autonomous operations based on detected objects, locations of the detected objects, and/or other related parameters. This may include controlling the stated torque sources and actuators as well as providing images, indications, and/or instructions via the infotainment system 366.

The telematics module 362 may include transceivers 382 and a telematics control module 384, which may be used for communicating with other vehicles, networks, edge computing devices, and/or cloud-based devices. The BCM 360 may control the modules and systems 362, 363, 364, 366, 370, 376 and other actuators, devices and systems (e.g., the actuators 372 and the devices 374). This control may be based on data from the sensors 306.

FIG. 4 shows an example of one middleware node 400 may be a function that receives requests and response objects. Multiple middleware nodes may be implemented, which may communicate with each other. The middleware nodes may be programs, applications and/or programs running as part of an application. The middleware node 400 may including threads 402, 404 and accessing a queue 406 and a shared main memory 408. Although the middleware node 400 is shown having two threads, the middleware node 400 may include one or more threads. Each of the threads 402, 404 may implement a respective algorithm or portion of a single algorithm.

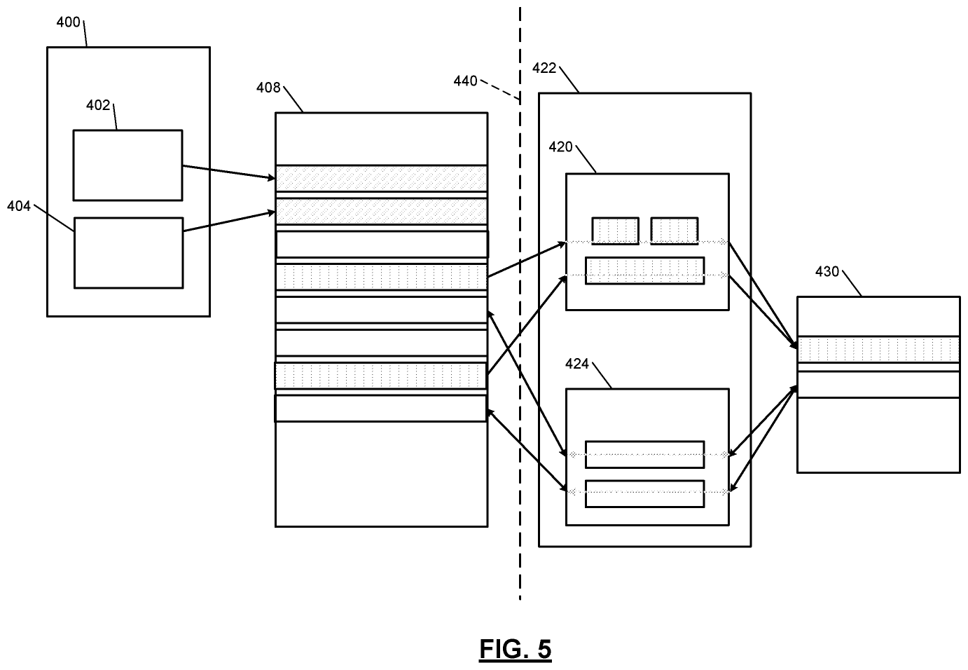

As an example, the first thread 402 may perform a detection algorithm and the second thread 404 may perform a segmentation and/or object aligning algorithm. As shown, the first thread 402 implements a first algorithm 410 and the second thread 404 implements a second algorithm 412. The threads 410, 412 may have access to respective local memories 414, 416. The queue 406 may refer to a portion of the main memory 305 of FIG. 3, remotely located memory, or a combination thereof. The shared main memory 408 refers to a portion (or assigned address region) of the main memory 305 that is shared by and accessible by each of the threads 410, 412 (or one or more cores implementing the threads). The threads 402, 404 are implemented as being part of a same process, although the operations may have traditionally been implemented as two or more separate processes. Since the threads are implemented as being part of a same process, the threads are able to share a same main memory region. This allows the code and data associated with the threads (referred to as thread code and thread data) and a GPU to be located near each other in the main memory, as shown in FIG. 5. Being part of the same process, allows computations for the threads to be implemented concurrently by the GPU.

The threads of the middleware node 400 are defined statically when the middleware node 400 is defined. Data shared among the threads is defined in a middleware node space for access protection. One or more queue(s) may be used for data communications and may respectively correspond to the algorithms implemented by the middleware nodes. All threads, shared data variables and queues may be configured when the middleware node 400 is initialized.

Each of the threads may be defined with properties supporting parallel execution. Each of the threads may include program statements, such as a commQList, a sharedMList, a gpuStreamList, a schedParam, an init( ) function, a run( ) function, and/or other program statements. The commQList is used to connect to the queues for transfer of small amounts of data (e.g., object detection and/or identification data) between threads and/or memory spaces. The sharedMList is used to connect to the shared main memory 408 for transfer of large amounts of data (e.g., data associated with an image).

The gpuStreamList is used to connect to channels for GPU computation. The schedParam may include parameters for scheduling when a resource contention exists between two or more threads. The schedParam may be used when arbitration is performed to determine which thread to execute. Threads may be executed concurrently and when there is a limited resource, the schedParam may be used to determine and/or identify which thread is able to use the resource first. The init( ) function is an initialization function that is used to initialize queues, shared memory, the gpuStreamList program statement, and the schedParam program statement for the threads. The run( ) function is a function implemented for normal execution of an algorithm. The init( ) and run( ) functions may be used to convert a middleware node for a process to a thread.

The middleware node 400 allows for parallel processing of threads, which allows larger amounts of data to be processed. For example, processing of 10 frames per second of eight megabyte images instead of 10 frames per second of 1 megabyte images. A GPU may include hundreds of cores (e.g., 256 cores) and only a portion of the cores is traditionally used by a single middleware node at a time. The GPU would traditionally execute the algorithm computations for a first middleware node before executing the algorithm computations for a second middleware node. The GPU was traditionally not able to process information for images for two middleware nodes concurrently. As another example, due to the sequential time multiplexed implementation of the computations, only 20% of the cores of a GPU may be used to execute an algorithm for a middleware node while the other 80% of the cores are idle. The parallel GPU processing of thread computations as disclosed herein allows for a higher percentage utilization of GPU cores at a given moment in time.

FIG. 5 shows a diagram illustrating a shared memory usage of threads and parallel GPU processing for the threads 402, 404 as performed by the middleware node 400 of FIG. 4. The threads 402, 404 are shown implementing algorithms A1, A2, which may be the same or similar to the algorithms 107, 109 of FIG. 1A. The threads 402, 404 are shown sharing a same memory region 406 of the shared main memory 408. The memory region 406 includes: the first and second code associated with the first algorithm A1:c1, A1:c2; the first and second code associated with the second algorithm A2:c1, A2:c2; the first algorithm data A1 data; the GPU computations g11, g12; the first GPU data g1; the second algorithm data A2 data; the GPU computations g21; and the second GPU data g2. The codes for the different threads are copied concurrently into the same address space region 406 of the shared main memory 408. The data for the threads are also copied concurrently into the address space region 406 of the shared main memory 408. Each thread has one or more dedicated streams for GPU operations. Operations from the same stream are provided into a queue (or first-in-first-out (FIFO) memory). Operations from different streams are performed concurrently (or in parallel) when sufficient resources are available. For example the GPU codes g12, g11 for the first algorithm may be provided to an execution engine (or module) 420 of the GPU driver 422 while providing the GPU code g21 for the second algorithm to the execution engine 420. The execution engine 420 may concurrently execute the GPU computations g12, g11, g21 and store resultant GPU data (g1 data and g2 data) in the GPU memory 430. The GPU computations g12, g11 and/or g21 may be stored in the GPU memory 430. A copy engine (or module) 424 of the GPU driver 422 may concurrently copy the GPU data g1 and g2 from the GPU memory 430 to the memory region 406. Dashed line 440 separates CPU processing to the left of the line 440 and parallel GPU processing to the right of the line 440.

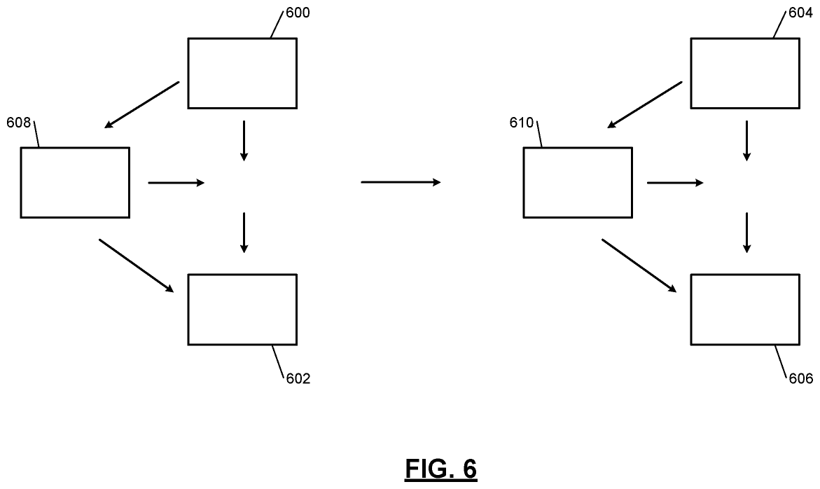

FIG. 6 shows mapping communication differences between process-based message transfers and thread-based message transfers. The message transfers are between middleware nodes and between middleware threads and are for transfers of small amounts of data (less than a predetermined amount of data).

Communications among middleware nodes use message queues. A data structure defines the information to be exchanged. A publish-subscribe mechanism is used for transparency. Middleware nodes N1 and N2 (or 600, 602) and threads T1 and T2 (604, 606) are shown along with message queues 608, 610. The message queues 608, 610 may be portions of main memory of a vehicle or elsewhere. The queues 608, 610 may be on-board memory of a vehicle or remotely located. The queues 608, 610 may be implemented as FIFO memory spaces that are applicable for small data transfers.

The middleware node N1 may indicate to the other middleware node N2 that N1 is planning to send a message, referred to as publishing the message. This may include sending an advertisement to the message queue 608. The second node N2 may then acknowledge the message and trigger a callback. The second node N2 subscribes to the message queue to receive the message, may perform block waiting to receive the message, and may access the message queue to receive the message.

Communications among the threads T1 and T2 for small data transfers include use of message queues. The publish function maps to a send operation in the thread-based environment. The subscribe function maps to a receive operation in the thread-based environment. The mapping is done at design time. Thread T1 may create, map and send the message to the message queue 610. The thread T1 may then receive the message by accessing the message queue 610. The thread T2 may then receive and later destroy the message. Each thread may create, map and/or destroy messages.

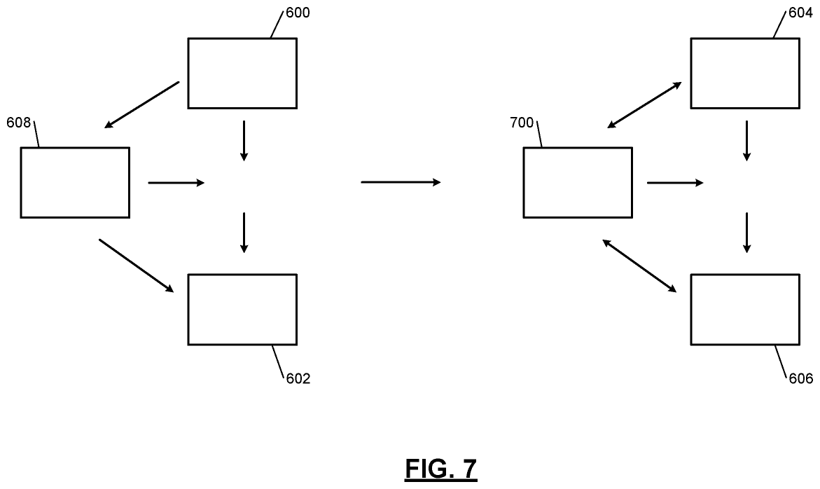

FIG. 7 shows mapping communication differences between process-based message transfers and thread-based message transfers of large amounts of data (e.g., image data). The message transfers are between middleware nodes and between middleware threads.

As stated above for FIG. 6, communications among middleware nodes use message queues. A data structure defines the information to be exchanged. A publish-subscribe mechanism is used for transparency. In FIG. 7, middleware nodes N1 and N2 (or 600, 602) and threads T1 and T2 (604, 606) are shown along with the message queue 608 and a shared main memory 700. The middleware node N1 may indicate to the other middleware node N2 that N1 is planning to send a message, referred to as publishing the message. This may include sending an advertisement to the message queue 608. The second node N2 may then acknowledge the message and trigger a callback. The second node N2 subscribes to the message queue to receive the message, may perform block waiting to receive the message, and may access the message queue to receive the message. Thus, data is transferred between the middleware nodes N1 and N2 in the same manner independent of the amount of data using the message queue 608.

Communications among the threads T1 and T2 for large data transfers is different from communication among the threads T1 and T2 for small data transfers. For large data transfers the threads use the shared main memory 700 that is onboard a corresponding vehicle instead of a queue. Queues are applicable for small data transfers, but are not suitable for large data transfers due to the associated lag time. Queues are suitable for small back and forth data transfers, but experience substantial delays when being used to transfer large amounts of data.

Also, by using a shared memory, duplicate copying of the data is avoided, which minimizes delays and power consumed. When transferring small amount of data with queues: the data must be transferred from a local memory of a first middleware node; the corresponding pointer of the data must be “flattened” (or converted) prior to being moved into the queue; the data and flattened pointer are transferred to the queue; the data and flattened pointer are transferred from the queue to a second middleware node; the pointer is deflattened into a format for the second middleware node; and the data is stored in another local memory of the second middleware node. The flattening of the pointer may refer to the restoring of the pointer into an original structure and/or format. Examples of the local memory are shown in FIG. 4.

In contrast, when using a shared main memory, the large amount of data is accessible by each of the threads T1 and T2 and no pointer needs to be flattened (or converted) for use by the threads. Data is stored a single time into the shared main memory space and is then accessible by each of the threads T1 and T2. As an example, both threads are able to call a detection image from the shared main memory. Any thread generating a duplicate message for stored data, is informed that the same message was previously created and data is already stored in the shared main memory. When the threads T1 and T2 both call the function “shared memory create” for the same shared memory space, then one is permitted to create the shared memory space and the other thread receives a pointer for the shared memory space. The arbitration for this process may be performed by a core implementing one or more of the threads T1 and T2.

For the threads T1 and T2, each generated message maps to the shared main memory 700 having a same data structure. The publish function is mapped to a protected write operation in the thread-based environment. The subscribe function maps to a protected read operation in the thread-based environment. A wait-free lock-free synchronization may be used. All mappings are performed at design time.

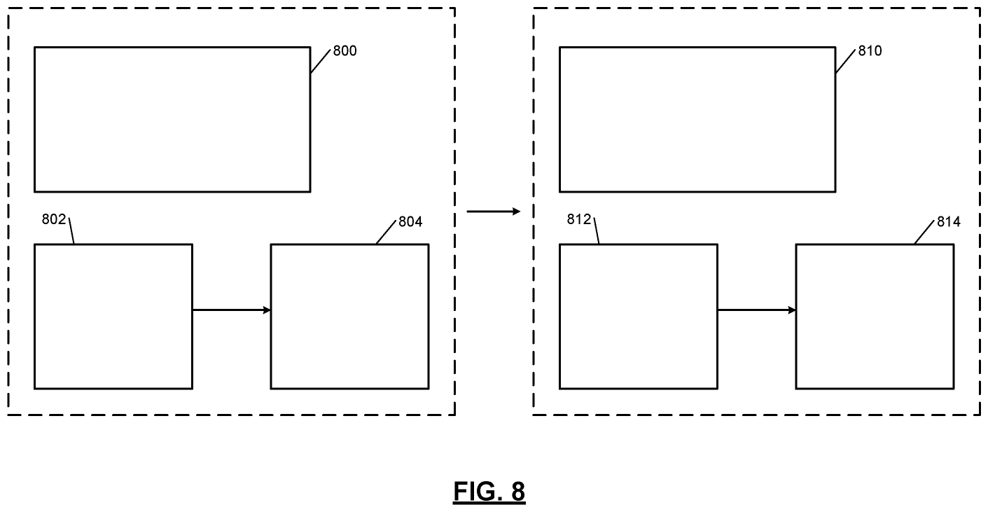

FIG. 8 shows differences between process-based mapping and thread-based mapping of scheduled parameters. A middleware node is scheduled using parameters for process scheduling. This includes trigger rate setting, processor affinity, priority level (or NICE level) setting, and scheduling policies. By default, middleware nodes are scheduled using a round-robin (RR) policy. As an example, a middleware node N (800) is shown and has: a trigger rate (or preset middleware rate); a callback(sub) (or callback subscribe function); an affinity set at cpu.set; a priority level between 0-255; and FIFO, RR and NICE level policies. The middleware node N has: a corresponding neural network driver N-Driver 802 that operates at 10 Hz, uses cpu0, has a priority level of 10, and uses a FIFO publish function FIFO pub(k); and a node multi-network 804 that starts based on output from the N-Driver 802 and a callback(data) function using cpu1 according to a priority level of 8 and a FIFO policy.

The thread of a middleware node inherits parameters of the original middleware node. The policies are in the scope of a single node. The policies of threads in a node may preserve those of the original nodes using a node level parameter. When thread policies cannot preserve the node schedule, that thread may callback to a middleware node. A thread T (810) is shown and has: a trigger timer and a wait(data) (or wait function); an affinity set at cpu.set; a priority level between 0-255; and FIFO, RR and NICE level policies. The thread T has: a corresponding neural network driver T-Driver 812 that operates at timer (10 Hz), uses cpu0, has a priority level of 10, and transfers data according to a FIFO policy; and a node multi-network 814 that starts based on output from the T-Driver 812 and a wait(data) function using cpu1 according to a priority level of 8 and a FIFO policy.

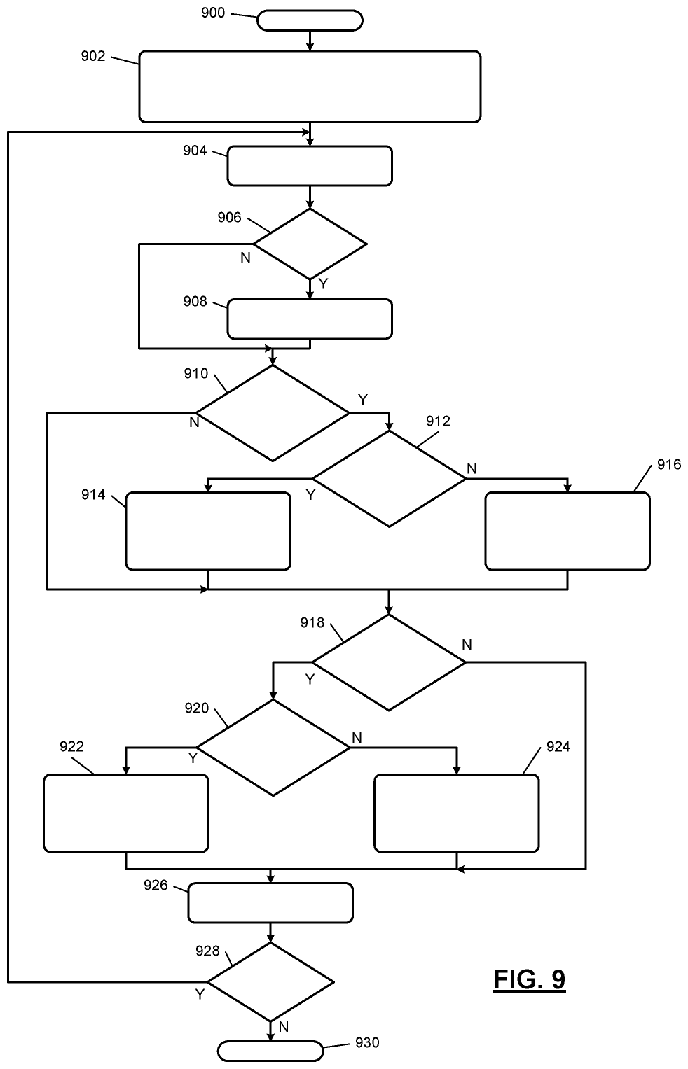

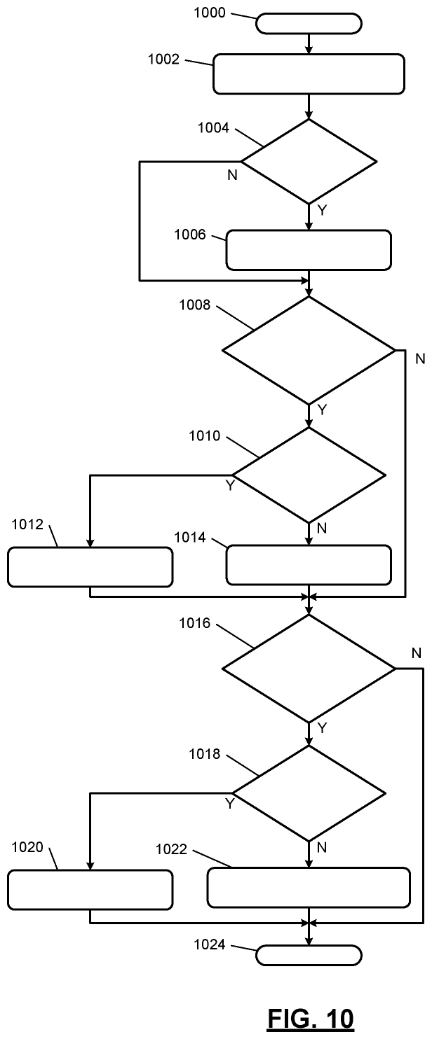

The following methods of FIGS. 9-10 may be implemented by, for example, one of the controllers 303 of FIG. 3. FIG. 9 shows a mapping method for defining a queue and a share main memory space. The operations of the method may be iteratively performed. The method may begin at 900. At 902, the controller may find a middleware node application process (or node Ni, where i is an number of the node) to execute in parallel with one or more other middleware node application processes.

At 904, the controller creates a thread Ti for the noe Ni. At 906, the controller determines whether to use a GPU 304. If yes, operation 908 is performed, otherwise operation 910 is performed. At 908, the controller defines a stream Si for the thread Ti.

At 910, the controller determines whether the node Ni is publishing data Di. If yes, operation 912 is performed, otherwise operation 918 is performed. At 912, the controller determines whether the amount of data is small (i.e. less than a predetermined and/or set amount of data) and/or the data is of a certain type known to include a small amount of data. If yes, operation 914 is performed, otherwise operation 916 is performed. At 914, the controller defines a queue space for when the thread Ti is performing sending operations. At 916, the controller defines a shared main memory address space for the thread Ti when performing writing operations.

At 918, the controller determines whether the node Ni is subscribing to the data Di. If yes, operation 920 is performed, otherwise operation 926 is performed. At 920, the controller determines whether the amount of data Di is small. If yes, operation 922 is performed, otherwise operation 924 is performed. At 922, the controller defines a queue space for the thread Ti when performing receiving operations. At 924, the controller defines a shared main memory address space for the thread Ti when performing reading operations. At 926, the controller schedules parameters.

At 928, the controller determines whether there is another middleware node to execute in parallel with the previously mapped middleware nodes. If yes, operation 904 may be performed, otherwise the method may end at 930.

FIG. 10 shows a thread initialization method. The operations of the method may be iteratively performed. The method may begin at 1000. At 1002, the controller sets scheduled parameters. At 1004, the controller determines whether there is multiple GPU streams. If yes, operation 1006 is performed, otherwise operation 1008 is performed.

At 1006, the controller initializes the GPU. At 1008, the controller determines whether communication and/or the transfer of data via a queue is appropriate. If yes, operation 1010 is performed, otherwise operation 1016 may be performed.

At 1010, the controller determines whether communication with a queue already exists (or allocated). If yes, operation 1012 is performed, otherwise operation 1014 is performed.

At 1012, the controller connects to the existing allocated queue. At 1014, the controller creates and connects to a queue. At 1016, the controller determines whether use of a shared main memory address space is appropriate. If yes, operation 1018 is performed, otherwise operation 1024 is performed.

At 1018, the controller determines whether a shared main memory address space has already been allocated. If yes, operation 1020 is performed, otherwise operation 1022 is performed. At 1020, the controller connects to the existing allocated shared main memory region. At 1022, the controller creates and connects to a shared main memory region. Subsequent to operations 1020, 1022, the method may end at 1024.

The above provided examples enable efficient usage of hardware resources and improve throughputs and resource utilization, which minimizes the overall system cost.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to a controller, a portion of a controller, or be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A system comprising:
a queue configured to transfer a message between a first thread and a second thread, wherein the first thread and the second thread are implemented as part of a single process, and wherein an amount of data corresponding to the message is less than a set amount of data;
a memory configured for sharing data between the first thread and the second thread, wherein an amount of the data shared between the first thread and the second thread is greater than the set amount of data; and
a controller configured to execute the single process including concurrently executing (i) a first middleware node process as the first thread, and (ii) a second middleware node process as the second thread.

2. The system of claim 1, wherein the first thread and the second thread share a same region of a main memory address space of the memory for thread code, thread data, graphics processing module code, and graphics processing module data.

3. The system of claim 1, further comprising a graphics processing module comprising an execution module configured to execute code for the first thread concurrently with code for the second thread.

4. The system of claim 1, further comprising a graphics processing module comprising a copy module configured to copy graphics processing module data for the first thread concurrently with graphics processing module data for the second thread.

5. The system of claim 1, further comprising:
a graphics processing module memory; and
a graphics processing module configured to concurrently transfer data for the first thread and the second thread between a main memory address space of the memory and the graphics processing module memory.

6. The system of claim 1, further comprising a graphics processing module, wherein:
the first thread generates first computations for a first algorithm of the first middleware node; and
the second thread generates second computations for a second algorithm of the second middleware node; and
the graphics processing module concurrently executes the first computations for a second frame while executing the second computations for a first frame, wherein the second frame is captured and received subsequent to the first frame.

7. The system of claim 1, wherein the first thread and the second thread are implemented as part of a single middleware node.

8. The system of claim 1, wherein the controller is configured to:
allocate and define a main memory address space of the memory to be shared by the first thread and the second thread; and
define the queue to be used by the first thread and the second thread.

9. The system of claim 8, wherein:
the main memory address space is dedicated for reading and writing operations; and
the queue is dedicated for sending and receiving operations.

10. The system of claim 1, wherein the controller is configured to:
determine whether use of the queue is appropriate, and if appropriate, connecting to the queue if allocated and allocating the queue if not allocated; and
determine whether use of a shared region of the memory is appropriate, and if appropriate, accessing the shared region if allocated and allocating the shared region if not allocated.

11. A method comprising:
allocating a queue for transfer of a message between a first thread and a second thread, wherein the first thread and the second thread are implemented as part of a single process, and wherein an amount of data corresponding to the message is less than a set amount of data;
allocating a memory for sharing data between the first thread and the second thread, wherein an amount of the data shared between the first thread and the second thread is greater than the set amount of data; and
executing the single process including concurrently executing (i) a first middleware node process as the first thread, and (ii) a second middleware node process as the second thread.

12. The method of claim 11, wherein the first thread and the second thread share a same region of a main memory address space of the memory for thread code, thread data, graphics processing module code, and graphics processing module data.

13. The method of claim 11, further comprising executing code via a graphics processing module and for the first thread concurrently with code for the second thread.

14. The method of claim 11, further comprising copying graphics processing module data via a graphics processing module and for the first thread concurrently with graphics processing module data for the second thread.

15. The method of claim 11, further comprising concurrently transferring data for the first thread and the second thread between a main memory address space of the memory and a graphics processing module memory.

16. The method of claim 11, further comprising:
generating first computations via the first thread for a first algorithm of the first middleware node; and
generating second computations via the second thread for a second algorithm of the second middleware node; and
concurrently executing via a graphics processing module the first computations for a second frame while executing the second computations for a first frame, wherein the second frame is captured and received subsequent to the first frame.

17. The method of claim 11, wherein the first thread and the second thread are implemented as part of a single middleware node.

18. The method of claim 11, further comprising:
allocating and define a main memory address space of the memory to be shared by the first thread and the second thread; and
defining the queue to be used by the first thread and the second thread.

19. The method of claim 18, wherein:
the main memory address space is dedicated for reading and writing operations; and
the queue is dedicated for sending and receiving operations.

20. The method of claim 11, further comprising:
determining whether use of the queue is appropriate, and if appropriate, connecting to the queue if allocated and allocating the queue if not allocated; and
determining whether use of a shared region of the memory is appropriate, and if appropriate, accessing the shared region if allocated and allocating the shared region if not allocated.
